(19) United States
(12) Patent Application Publication
(10) Pub. No.: US 2012/0290948 A1
(43) Pub. Date: Nov. 15, 2012

(54) SYSTEM AND METHOD FOR PROVIDING A VIRTUAL SPACE WITH INDIVIDUALIZED MAPS

(75) Inventors: Orion ELENZIL, San Francisco, CA (US); Jeffrey Hyman, Tiburon, CA (US)

(73) Assignee: Idle Games, San Francisco, CA (US)

(21) Appl. No.: 13/103,847

(22) Filed: May 9, 2011

(51) Int. Cl. G06F 3/01

(52) U.S. Cl. 715/753

(57) ABSTRACT

A virtual space may be provided to users in which places in the virtual space are associated with individual users. Individual ones of such places may be locations or spaces within the virtual space that the individual users control, tend, decorate, own, and/or are associated with in other ways. The spatial arrangement of the places in the virtual space, represented by a map of the virtual space, may be customized for individual users to instigate and/or facilitate interactions and/or engagement of the users with and in the virtual space. As such, individual spatial arrangements of the places, or maps of the virtual space, may be created for individual ones of the users.

### FIELD OF THE INVENTION

The invention relates to the determination of individualized maps of a virtual space for users, wherein the individual maps are configured to instigate and/or facilitate interactions between the users in the virtual space.

### BACKGROUND OF THE INVENTION

Systems that provide virtual spaces to users are known. Users may be enabled to interact with the virtual spaces and/or each other in the virtual spaces. The virtual spaces may be configured to simulate physical spaces. As such, typically there is a single map of the virtual space, and a single arrangement of the locations or spaces in a virtual space that is uniform for all (or substantially all) users of the virtual space.

### SUMMARY

One aspect of the invention relates to a system and method of hosting a virtual space in which places in the virtual space are associated with individual users. Individual ones of such places may be locations or spaces within the virtual space that the individual users control, tend, decorate, own, and/or are associated with in other ways. The spatial arrangement of the places in the virtual space, represented by a map of the virtual space, may be customized for individual users to instigate and/or facilitate interactions and/or engagement of the users with and in the virtual space. As such, individual spatial arrangements of the places, or maps of the virtual space, may be created for individual ones of the users.

The system may include a server configured to host the virtual space to client computing platforms that present the virtual space to the users. The server may be configured to execute one or more of a place module, an interaction module, a relationship module, a user matching module, a distance module, a map module, and/or other modules.

The place module may be configured to instance separate spatial places within the virtual space, wherein the separate spatial places are associated with individual users. For example, the places may include a first place associated with a first user and a second place associated with a second user. The place module may be further configured to implement the instances of the places to determine views of the virtual space for presentation to users on the client computing devices. This may enable users to interact with the virtual space and each other in the virtual space by performing actions in the places based on input of the users received from the client computing platforms.

The interaction module may be configured to monitor interactions of users with the virtual space and/or each other within the virtual space. This may include monitoring, for a given user, one or more of times at which the given user is logged in to the virtual space, areas of the virtual space the given user views or interacts with or in, other users the given user interacts with, the nature and/or content of interactions of the given user with other users, activities participated in within the virtual space, level, powers, or skill attained in the virtual space, inventory items obtained in the virtual space, and/or other interactions of the given user with the virtual space and/or other users. Monitoring such interactions may include determining one or more metrics that parameterize the monitored interactions.

The relationship module may be configured to establish relationships between users. The relationships may be established based on relationship requests and acceptances received from the users. The relationships may be identified and/or established based on interactions between users. For example, reciprocation or cooperation in one or more interactions or activities may give rise to establishment of a relationship between users. Activities that may give rise to establishment of a relationship between users may include one or more of visiting (and/or accepting visits) between users within the virtual space, searching for another player (e.g., using a search portal provided by the relationship module), sending messages, items, or other communications to another user within the virtual space, and/or other activities. The relationship module may be configured such that relationships are parameterized by a strength metric quantifying a strength of relationship. The strength of a relationship may increase as the users interact with each other more frequently, through deeper interactions, and/or may increase responsive to other activities. The strength of a relationship may decrease or decay over time if the users do not continue to participate or interact in the virtual space with each other. Such relationships may include friendships, guilds (with guild-mates), alliances, connections, and/or other relationships.

The user matching module may be configured to determine likelihoods that specific sets of two or more users will enjoy participating together in interactions in the virtual space. Determining these likelihoods may include determining one or more metrics quantifying the likelihoods. The likelihoods may be determined based on interactions monitored by the interaction module, relationships established by relationship module, and/or other information.

The distance module may be configured to determine distances between places which are implemented in generating the maps of the virtual space for the individual users. The distances may be configured to instigate and/or facilitate participation together by users in interactions within the virtual space. For example, the distances between the first place and the other places for a first map for the first user may be determined such that places corresponding to users the first user is most likely to participate in interactions with may be closer to the first place than places corresponding to users the first user is less likely to participate in interactions with. Similarly, the distances between the second place and the other places for a second map for the second user may be determined such that places corresponding to users the second user is most likely to participate in interactions with may be closer to the second place than places corresponding to users the second user is less likely to participate in interactions with. The distances may be determined based on interaction monitoring performed by the interaction module, relationships established by the relationship module, likelihoods determined by the user matching module, and/or other information.

The map module may be configured to determine different maps of the virtual space for the individual users. The maps determined for the individual users may have spatial arrangements of the places which may instigate and/or facilitate participation in interactions in the virtual space by the users. For example, the arrangement of the places of the virtual space in the first map may be different than the arrangement of the places of the virtual space in the second map. The differences in the arrangements of the places of the virtual space between the first map and the second map may be a function of differences in the interactions of the first user with the virtual space and/or other users and interactions of the second user with the virtual space and/or other users. In the first map, the distances between the first place and the other places may be the distances determined between the first place and the other places by the distance module. The distances between the other places in the first map may not be the distances determined for sets of the other places by the distance module. Similarly, in the second map, the distances between the second place and the other places may be the distances determined between the second place and the other places by the distance module. The distances between the other places in the first map may not be the distances determined for sets of the other places by the distance module. As such, the spatial arrangement of the places in the first map may be provided as a customized version of the virtual space for the first user that enhances the interactivity and/or engagement of the first user with the virtual space. The spatial arrangement of the places in the second map may be provided as a customized version of the virtual space for the second user that enhances the interactivity and/or engagement of the second user with the virtual space.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide a virtual space to users.

FIG. 2 illustrates a map of a virtual space representing a spatial arrangement of places within the virtual space.

FIG. 3 illustrates a map of a virtual space representing a spatial arrangement of places within the virtual space.

FIG. 4 illustrates a method of providing a virtual space to users.

### DETAILED DESCRIPTION

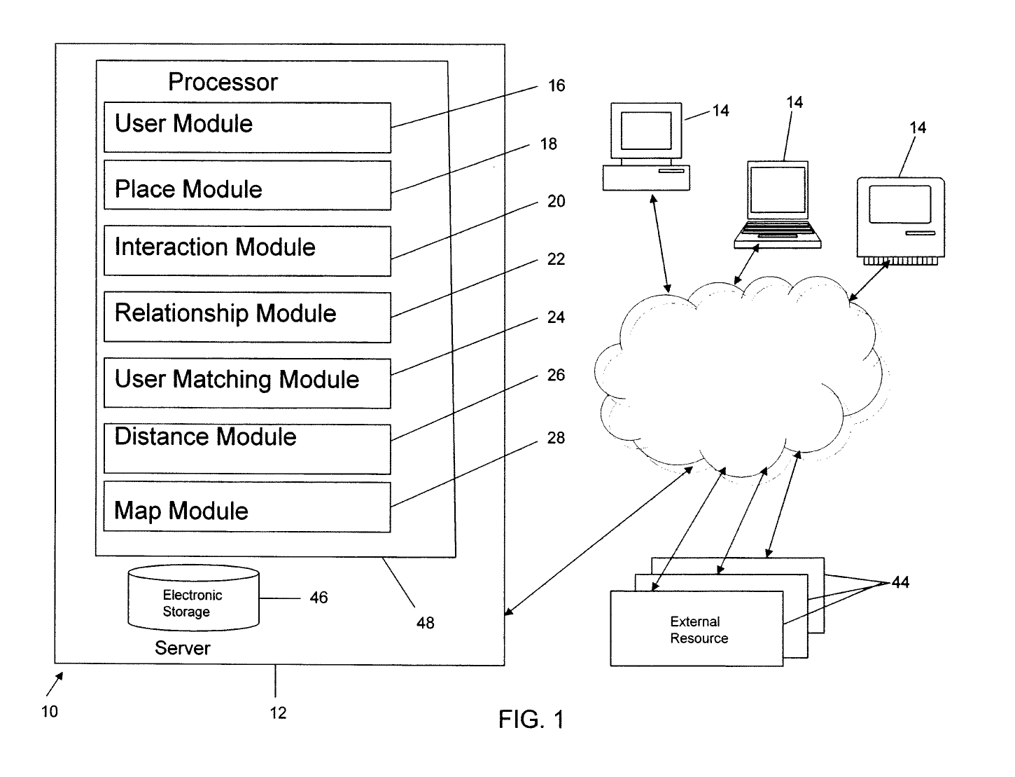

FIG. 1 illustrates a system 10 configured to provide a virtual space to users. The virtual space may be a space in which a game is played, in which users communicate with each other, and/or in which other activities are conducted. Providing the virtual space may include hosting the virtual space over a network. In some implementations, system 10 may include a server 12. The server 12 may be configured to communicate with one or more client computing platforms 14 according to a client/server architecture. The users may access system 10 and/or the virtual space via client computing platforms 14.

The server 12 may be configured to execute one or more computer program modules. The computer program modules may include one or more of a user module 16, a place module 18, an interaction module 20, a relationship module 22, a user matching module 24, a distance module 26, a map module 28, and/or other modules.

The user module 16 may be configured to access and/or manage one or more user profiles and/or user information associated with users of the system 10. The one or more user profiles and/or user information may include information stored by server 12, one or more of the client computing platforms 14, and/or other storage locations. The user profiles may include, for example, information identifying users (e.g., a username or handle, a number, an identifier, and/or other identifying information) within the virtual space, security login information (e.g., a login code or password), virtual space account information, subscription information, virtual currency account information (e.g., related to currency held in credit for a user), relationship information (e.g., information related to relationships between users in the virtual space), virtual space usage information, demographic information associated with users, interaction history among users in the virtual space, information stated by users, purchase information of users, browsing history of users, a client computing platform identification associated with a user, a phone number associated with a user, and/or other information related to users.

The place module 18 may be configured to instance separate places within the virtual space. The places may be instanced as separate spatial areas within the virtual space. The place module 18 may be configured to implement the instances of the places to determine views of the places. The views may then be communicated (e.g., via streaming, via object/position data, and/or other information) from server 12 to client computing platforms 14 for presentation to users. The view determined and transmitted to a given client computing platform 14 may correspond to a user character being controlled by a user via the given client computing platform 14. The view determined and transmitted to a given client computing platform 14 may correspond to a location in the virtual space (e.g., the location from which the view is taken, the location the view depicts, and/or other locations), a zoom ratio, a dimensionality of objects, a point-of-view, and/or view parameters. One or more of the view parameters may be selectable by the user

Places within the virtual space may individually comprise simulated spaces (e.g., similar to a physical space segmented into spatially separate areas) that are accessible by users via clients (e.g., client computing platforms 14) that present the views of the virtual space to a user. The separate places may be depicted as separate islands, rooms, neighborhoods, cities, arenas or stadiums, and/or other places. The simulated space of a given place within the virtual space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the destination node, and/or surface features of a surface or objects that are “native” to the destination node. In some instances, the topography may describe a surface (e.g., a ground surface) that runs through at least a substantial portion of the place. In some instances, the topography may describe a volume with one or more bodies positioned therein (e.g., a simulation of gravity-deprived space with one or more celestial bodies positioned therein). The instances executed by place module 18 may be synchronous, asynchronous, and/or semi-synchronous.

The above description of the manner in which views of a place are determined by place module 18 is not intended to be limiting. The place module 18 may be configured to express one or more of the places of the virtual space in a more limited, or more rich, manner. For example, views determined for a given place may be selected from a limited set of graphics depicting an event in the given place. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places are contemplated.

Within the places instanced by place module 18, users may control characters, objects, simulated physical phenomena (e.g., wind, rain, earthquakes, and/or other phenomena), and/or other elements within the places to interact with the places and/or each other. The user characters may include avatars. As used herein, the term “user character” may refer to an object (or group of objects) present in the virtual space that represents an individual user. The user character may be controlled by the user with which it is associated. The user controlled element(s) may move through and interact with the virtual space (e.g., non-user characters in the virtual space, other objects in the virtual space). The user controlled elements controlled by and/or associated with a given user may be created and/or customized by the given user. The user may have an “inventory” of virtual goods and/or currency that the user can use (e.g., by manipulation of a user character or other user controlled element, and/or other items) within the virtual space.

The users may participate in the virtual space by controlling one or more of the available user controlled elements in the places. Control may be exercised through control inputs and/or commands input by the users through client computing platforms 14. The users may interact with each other through communications exchanged within the virtual space. Such communications may include one or more of textual chat, instant messages, private messages, voice communications, and/or other communications. Communications may be received and entered by the users via their respective client computing platforms 14. Communications may be routed to and from the appropriate users through server 12 (e.g., through place module 18).

The interaction module 20 may be configured to monitor interactions of the users with the virtual space and/or each other within the virtual space. This may include monitoring, for a given user, one or more of times at which the given user is logged in to the virtual space, areas of the virtual space the given user views or interacts with or in, other users the given user interacts with, the nature and/or content of interactions of the given user with other users, activities participated in within the virtual space, level, powers, or skill attained in the virtual space, inventory items obtained in the virtual space, and/or other interactions of the given user with the virtual space and/or other users. Some or all of the information generated by interaction module 20 in monitoring the interactions of the users may be stored to the user profiles managed by user module 16.

At a given time, interaction module 20 may determine a set of users that are currently engaged with the virtual space and/or a set of users that are currently not engaged with the virtual space. Being engaged with the virtual space may refer to being logged in to the virtual space, performing some action or interaction within the virtual space within some period of time (e.g., the last 2 minutes), and/or other taking some other action indicating ongoing and contemporaneous engagement with the virtual space.

The interaction module 20 may be configured to determine, for individual users, an activity metric that indicates an activity level within the virtual space. The activity metric may be determined based on one or more of log in frequency, amount of time logged in to the virtual space within a rolling time period (e.g., over the last day, week, month, or other rolling time period), average amount of time logged in to the virtual space over some length of time (e.g., per day, per week, and/or other length of time), average log in session time over a rolling time period, number of inter-user communications over a length of time, number of inter-user communications per log in, number of relationships with other users in the virtual space, number of new relationships with other users in the virtual space within a rolling time period, modifications to the virtual space within some period of time, and/or other activity parameters.

The relationship module 22 may be configured to establish relationships between users within the virtual space. Such relationships may include one or more of friendships, guilds (with guild-mates), alliances, connections, and/or other relationships. The relationship module 22 may establish relationships based on relationship requests and acceptances received from users. Establishment of a relationship may be initiated by a single communication (e.g., a request) initiated by a given user requesting a relationship between the given user and one or more other users. Establishment of a relationship may require a first communication from the given user to be approved by the one or more other users. The relationship module may be configured to identify and/or establish relationships based on interactions between users. For example, reciprocation or cooperation in one or more interactions or activities may give rise to establishment of a relationship between users. Activities that may give rise to establishment of a relationship between users may include one or more of visiting (and/or accepting visits) between users within the virtual space, searching for another player (e.g., using a search portal provided by the relationship module), sending messages, items, or other communications to another user within the virtual space, and/or other activities. Such relationships may include friendships, guilds (with guild-mates), alliances, connections, and/or other relationships. Relationships may include one or more types of relationships that have a functional purpose or impact within the virtual space. Relationships may include one or more types of relationships that are merely a social construct within the virtual space and do not have a functional result or purpose.

The relationship module 22 may be configured to parameterize the strength of established relationships. This may include determining a strength metric that quantifies a strength of a relationship between two or more users. The strength metric may increase when one user reciprocates action from another. Such action may include, for example, sending a message, visiting an area or character associated with another user, sending a gift (e.g., virtual good(s), virtual currency, and/or other gifts), casting a power or spell on an area or character associated with another user, and/or other actions. In determining the strength metric, relationship module 22 may weight some actions more significantly than others. This weighting may depend, for example, on an amount of value (e.g., time, effort, virtual currency, virtual good, and/or other value) expended by a user in the action. In determining the strength metric, relationship module 22 may weight actions based on time. For example, a first action by a first user toward a second user that reciprocates a second action by the second user toward the first user may be afforded greater weight the closer the first action is in time to the second action. The relationship module 22 may be configured such that strength metric (and/or the weight afforded to actions upon which the strength metric is based) decay over time. As such, if a strong relationship exists between the first user and the second user at a first point in time, the strength metric will become lower and lower over time if the first user and the second user do not continue to participate and/or interact in the virtual space with each other.

The user matching module 24 may be configured to determine likelihoods that specific sets of two or more users will enjoy interacting with each other in the virtual space. This may include determining one or more metrics indicating such likelihoods. The user matching module 24 may be configured such that a likelihood determined for a set of users may be interaction-type specific. The interaction-type may include one or more of participating in quests together, participating in a guild together, participating in an exchange of virtual goods and/or currency, participating in inter-user communications within the virtual space, playing a game against each other, visiting (and/or accepting visits) between users within the virtual space, searching for another player (e.g., using a search portal provided by the relationship module), sending messages, items, or other communications to another user within the virtual space, and/or other interactions.

To determine the likelihoods, user matching module 24 may use as inputs the interactions monitored by interaction module 20. For example, determinations by user matching module 24 may reflect that a set of users that consistently participate in the same types of interactions, and/or perform the same types of interactions in the same or similar manners would likely enjoy participating in such interactions with one another. As another non-limiting example, determinations by user matching module 24 may reflect temporal usage patterns of the set of users such that users having corresponding or complimentary temporal usage patterns may be more likely to enjoy participating in interactions with each other in the virtual space. The temporal usage pattern of a user may include a frequency of log-ins, a frequency of interactions in the virtual space, a length (or average length) of interactions, a pattern of timings of interactions participated in by the user (e.g., typical times of day, days of the week, and/or other patterns), user-to-user interactions within the virtual space over some period of time (e.g., a rolling window of time, and/or other periods of time), and/or temporal parameters of virtual space usage. The user matching module 24 may implement the interactions monitored by interaction module 20 in other ways.

To determine the likelihoods, user matching module 24 may use as inputs relationships between users established by relationship module 22, and/or the strength metrics determined by relationship module 22 that parameterize the strength of the relationships. For example, determinations by user matching module 24 may reflect that users that have established relationships may enjoy participating in interactions with each other in the virtual space. As another non-limiting example, determinations by user matching module 24 may reflect that a set of users having established relationships with another user in common (e.g., a first and second user each having an established relationship with a third user) may enjoy participating in interactions with each other in the virtual space. The user matching module 24 may implement the relationships established by relationship module 22 in other ways.

In some implementations, user matching module 24 may be configured to receive feedback from users on the likelihoods determined by user matching module 24. This may come in the form of selected or entered ratings (e.g., on a scale). The ratings may indicate the accuracy with which user matching module 24 has determined sets of users that enjoy participating in interactions together in the virtual space. The user matching module 24 may be configured to implement such ratings in further determinations of likelihoods that other sets of users will enjoy participating in interactions together within the virtual space. Other inputs may be used by user matching module 24 in determining the likelihoods and/or metrics.

The distance module 26 may be configured to determine distances between the places in the virtual space. The distance between two places may be determined by distance module 26 to instigate and/or facilitate interaction in the virtual space between the two users associated with the two places. As such, such a distance may be determined based on a relationship established by relationship module 22 between the two users, relationships of the two users with other users, previous interactions in the virtual world the two users have participated in together, previous interactions in the virtual world by the two users independent from each other, a likelihood the two users will enjoy participating in interactions in the virtual space determined by user matching module 24, and/or other parameters. The distance between the two places may reflect an activity level of one or both of the users. For example, as the general activity level of one or both of the users (e.g., as determined by interaction module 20) drops, the distance between the users may grow. Conversely, as the general activity level of one or both of the users increases, the distance between the users may shrink. This may reflect the concept that a user with a lower activity level may be less likely to engage in interactions with other users in the virtual space. The distance between the two places may reflect a current log-in status (e.g., as determined by interaction module 20) of the two users. For example, if both of the users are currently logged in and/or participating in the virtual space the distance between the two places may be less than if one and/or both of the users are currently not logged in and/or participating in the virtual space. The distance between the two places may be determined based on one or more other parameters. As will be apparent, the distances determined by distance module 26 may evolve over time based on participation by the users in the virtual space.

The map module 28 may be configured to determine different maps of the virtual space for individual ones of the users. The maps may be virtual maps of the virtual space. The maps may be presented to corresponding users by map module 28. For a given user, this may include a map display of the virtual space, and/or a depiction (e.g., an aerial depiction) of the virtual space in which the places are arranged according to the map determined by map module 28. For the given user, the map determined may represent (and/or dictate) the spatial arrangement of the places in the virtual space that is particular to the given user. As such, the spatial arrangements of the places for the individual users determined by map module 28 may result in individualized versions of the virtual space being presented to the different users, with spatial arrangement of places being a variable between the different versions of the virtual space. The spatial rearrangement of the places between the different versions of the virtual space may not impact the topography of the individual places. The places may be otherwise unaffected by the spatial rearrangement between the different versions of the virtual space. In some implementations, the places may be instanced to provide synchronous use by a plurality of users. In such implementations, the instances of the places are common between a plurality of versions of the virtual space provided to different users.

The map determined for the given user may have the given user's place at the center. The other places in the virtual space may be arranged with respect to the given user's place so that they have the distances to the given user's place determined by distance module 26. As such, the arrangement of the places in each map may be different because each map reflects the distances determined by distance module 26 for the corresponding user. The distances between the other places (e.g., the places associated users other than the given user) may not reflect the distances determined by distance module 26.

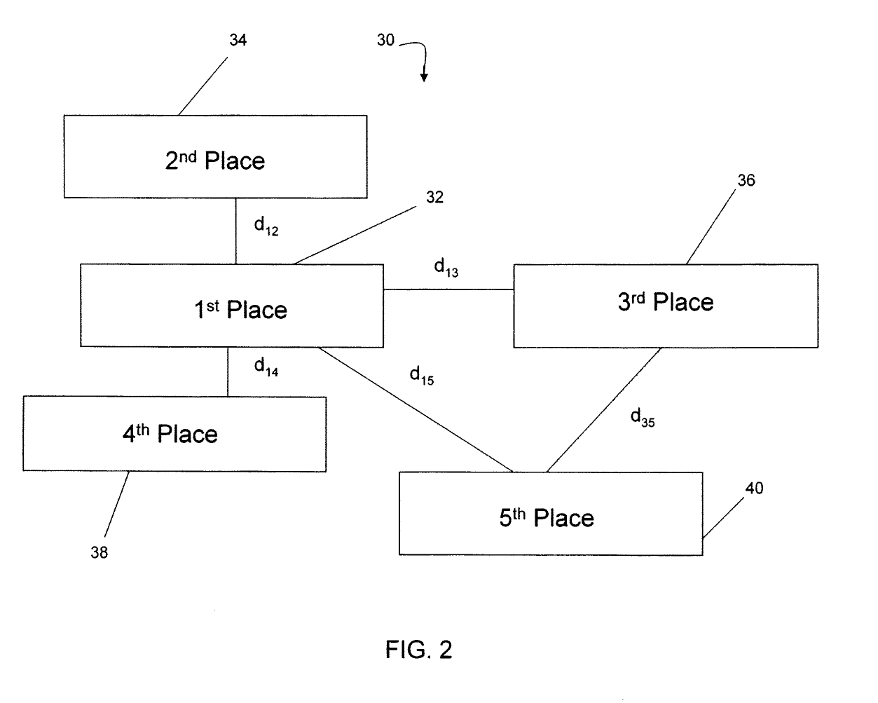

By way of illustration, FIG. 2 depicts a first map 30 of a virtual space determined for a first user by a map module that is similar to or the same as map module 28 (shown in FIG. 1 and described herein). The first map 30 may include a first place 32 associated with a first user, a second place 34 associated with a second user, a third place 36 associated with a third user, a fourth place 38 associated with a fourth user, a fifth place 40 associated with a fifth user, and/or other places. The arrangement of places 34, 36, 38, and 40 with respect to first place 32 may be determined to instigate and/or facilitate interactions by the first user with the other users. For example, the distances may be determined by a distance module that is the same as or similar to distance module 26 (shown in FIG. 1 and described herein). These distances include the distance between first place 32 and user matching module 24 (d₁₂), the distance between first place 32 and third place 36 (d₁₃), the distance between first place 32 and fourth place 38 (d₁₄), and the distance between first place 32 and fifth place 40 (d₁₅). The distances between the other places 34, 36, 38, and 40 may not be based on distances determined to instigate and/or facilitate interactions between users. For example, the distance between third place 36 and fifth place 40 (d₃₅) may be determined for first map 30 without regard for instigating and/or facilitating interactions between the third user and the fifth user. This may be because first map 30 has been determined for presentation to the first user, not the third user or the fifth user.

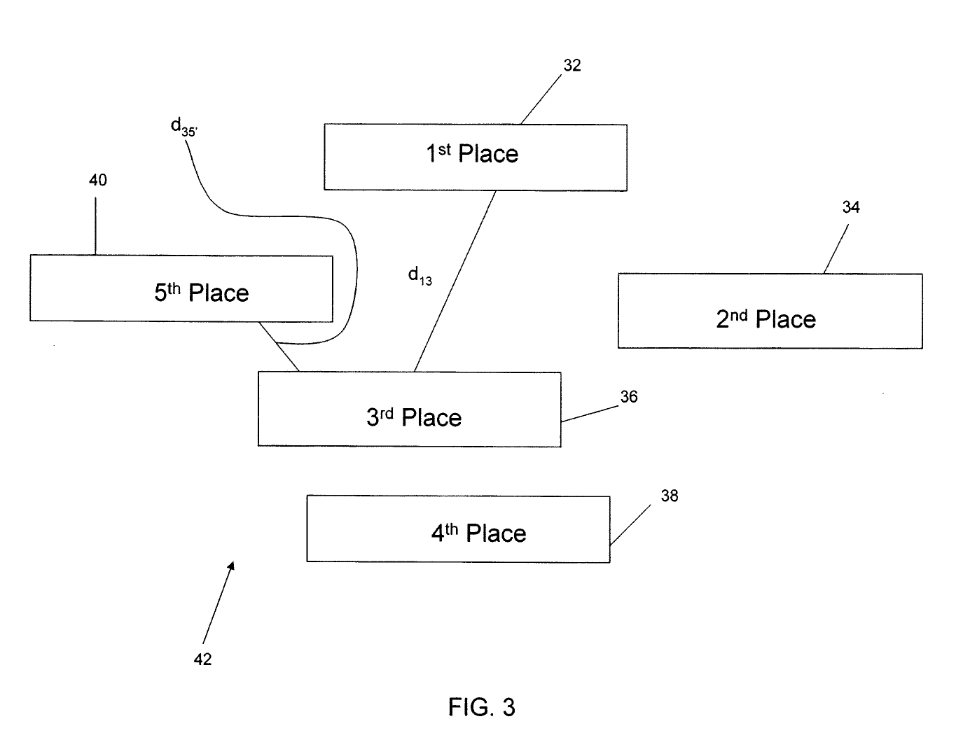

FIG. 3 illustrates a third map 42 determined by the map module for the third user referred to with respect to FIG. 2. In third map 42, the places 32, 34, 38, and 40 have been arranged with respect to third place 36 to instigate and/or facilitate interactions of the third user with the other users. This may include providing distances from third place 36 to first place 32, second place 34, fourth place 38, and/or fifth place 40 determined by a distance module the same as or similar to distance module 26 (shown in FIG. 1 and described herein). As a result of the arrangement of places first place 32, second place 34, fourth place 38, and fifth place 40 with respect to third place 36 being based on the instigation and/or facilitation of interactions with the third user, the distances between places 32, 34, 36, 38, and 40 may be different than these distances in FIG. 2. For example, the distance between third place 36 and fifth place 40 (d_{35′}) in third map 42 of FIG. 3 may be different than the distance between third place 36 and fifth place 40 (d₃₅) in first map 30 of FIG. 2. However, the distance between first place 32 and third place 36 (d₁₃) may be the same in each of first map 30 and third map 42 because these two places are the “centers” of the two maps.

Returning to FIG. 1, map module 28 may be configured such that the maps determined for the individual users continue to evolve over time. Such evolution may be responsive to individual events (e.g., anew relationship between users, a new interaction participated in by one or more users, and/or other events in the virtual space), current log in status of the users, general trends in usage by the users (e.g., changes in usage patterns, temporal usage patterns, and/or other trends), and/or other dynamic information.

The server 12, client computing platforms 14, and/or external resources 44 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which servers 12, client computing platforms 14, and/or external resources 44 may be operatively linked via some other communication media.

A given client computing platform 14 may include one or more processors configured to execute computer program modules. The computer program modules may be configured to enable an expert or user associated with the given client computing platform 14 to interface with system 10 and/or external resources 44, and/or provide other functionality attributed herein to client computing platforms 14. By way of non-limiting example, the given client computing platform 14 may include one or more of a desktop computer, a laptop computer, a handheld computer, a NetBook, a Smartphone, a gaming console, and/or other computing platforms.

The external resources 44 may include sources of information, hosts and/or providers of virtual environments outside of system 10, external entities participating with system 10, and/or other resources. In some implementations, some or all of the functionality attributed herein to external resources 44 may be provided by resources included in system 10.

The server 12 may include electronic storage 46, one or more processors 48, and/or other components. The server 12 may include communication lines, or ports to enable the exchange of information with a network and/or other computing platforms. Illustration of server 12 in FIG. 1 is not intended to be limiting. The server 12 may include a plurality of hardware, software, and/or firmware components operating together to provide the functionality attributed herein to server 12. For example, server 12 may be implemented by a cloud of computing platforms operating together as server 12.

Electronic storage 46 may comprise electronic storage media that electronically stores information. The electronic storage media of electronic storage 46 may include one or both of system storage that is provided integrally (i.e., substantially non-removable) with server 12 and/or removable storage that is removably connectable to server 12 via, for example, a port (e.g., a USB port, a firewire port, etc.) or a drive (e.g., a disk drive, etc.). Electronic storage 46 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 46 may include one or more virtual storage resources (e.g., cloud storage, a virtual private network, and/or other virtual storage resources). Electronic storage 46 may store software algorithms, information determined by processor 48, information received from server 12, information received from client computing platforms 14, and/or other information that enables server 12 to function properly.

Processor(s) 48 is configured to provide information processing capabilities in server 12. As such, processor 48 may include one or more of a digital processor, an analog processor, a digital circuit designed to process information, an analog circuit designed to process information, a state machine, and/or other mechanisms for electronically processing information. Although processor 48 is shown in FIG. 1 as a single entity, this is for illustrative purposes only. In some implementations, processor 48 may include a plurality of processing units. These processing units may be physically located within the same device, or processor 48 may represent processing functionality of a plurality of devices operating in coordination. The processor 48 may be configured to execute modules 16, 18, 20, 22, 24, 26, and/or 28. Processor 48 may be configured to execute modules 16, 18, 20, 22, 24, 26, and/or 28 by software; hardware; firmware; some combination of software, hardware, and/or firmware; and/or other mechanisms for configuring processing capabilities on processor 48.

It should be appreciated that although modules 16, 18, 20, 22, 24, 26, and/or 28 are illustrated in FIG. 1 as being co-located within a single processing unit, in implementations in which processor 48 includes multiple processing units, one or more of modules 16, 18, 20, 22, 24, 26, and/or 28 may be located remotely from the other modules. The description of the functionality provided by the different modules 16, 18, 20, 22, 24, 26, and/or 28 described below is for illustrative purposes, and is not intended to be limiting, as any of modules 16, 18, 20, 22, 24, 26, and/or 28 may provide more or less functionality than is described. For example, one or more of modules 16, 18, 20, 22, 24, 26, and/or 28 may be eliminated, and some or all of its functionality may be provided by other ones of modules 16, 18, 20, 22, 24, 26, and/or 28. As another example, processor 48 may be configured to execute one or more additional modules that may perform some or all of the functionality attributed below to one of modules 16, 18, 20, 22, 24, 26, and/or 28.

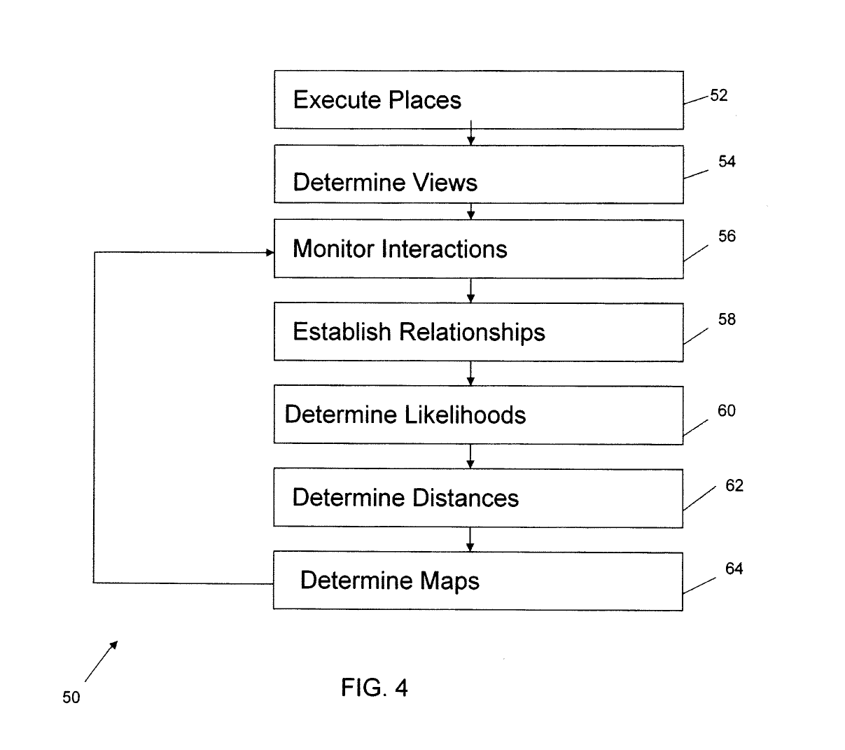

FIG. 4 illustrates a method 50 of hosting a virtual space to client computing devices for interaction by users. The operations of method 50 presented below are intended to be illustrative. In some embodiments, method 50 may be accomplished with one or more additional operations not described, and/or without one or more of the operations discussed. Additionally, the order in which the operations of method 50 are illustrated in FIG. 4 and described below is not intended to be limiting.

In some embodiments, method 50 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 50 in response to instructions stored electronically on an electronic storage medium. The one or more processing devices may include one or more devices configured through hardware, firmware, and/or software to be specifically designed for execution of one or more of the operations of method 50.

At an operation 52, instances of separate spatial places within the virtual space may be executed. The individual places may be associated with ones of the users. In some implementations, operation 52 may be performed by a place module the same as or similar to place module 18 (shown in FIG. 1 and described above).

At an operation 54, the instances of the places may be implemented to determine views of the virtual space for presentation to users on the client computing devices. Users may enabled to interact with the virtual space and/or each other in the virtual space by performing actions in the places based on input of the users received from the client computing platforms. In some implementations, operation 54 may be performed by a place module the same as or similar to place module 18 (shown in FIG. 1 and described above).

At an operation 56, interactions of the users in the virtual space may be monitored. This may include determining usage patterns of the users, temporal usage patterns of the users, activity levels of the users, current login status of the users, current interactions of the users, and/or other monitoring of the interactions. In some implementations, operation 56 may be performed by an interaction module the same as or similar to interaction module 20 (shown in FIG. 1 and described above).

At an operation 58, relationships may be established between users based on relationship requests and/or acceptances received from users. In some implementations, operation 58 may be performed by a relationship module the same as or similar to relationship module 22 (shown in FIG. 1 and described above).

At an operation 60, likelihoods that specific sets of two or more users will enjoy participating interactions in the virtual space together may be determined. Such likelihoods may be determined based on the monitoring of interactions at operation 56, the relationships established at operation 58, and/or other information. In some implementations, operation 60 may be performed by a user matching module the same as or similar to user matching module 24 (shown in FIG. 1 and described above).

At an operation 62, distances between the places may be determined. The distances may be determined to instigate and/or facilitate participation of users in interactions in the virtual space together. The distance for a given pair of places may be determined based on interaction monitoring performed at operation 56, the relationships established at operation 58, the likelihoods determined at operation 60, and/or other information. In some implementations, operation 62 may be determined by a distance module the same as or similar to distance module 26 (shown in FIG. 1 and described above).

At an operation 64, different maps of the virtual space may be determined for the individual users. The map determined for a given user may have the places associated with other users arranged with respect to the place associated with the given user so as to instigate and/or facilitate participation by the given user in interactions in the virtual space with other users. For example, the other places may be arranged at distances from the place associated with the given user determined at operation 62. The distances between the other places in the map for the given user may not correspond to the distances determined at operation 62 for the other users. In some implementations, operation 64 may be performed by a map module the same as or similar to map module 28 (shown in FIG. 1 and described above).

Method 50 may loop back over one or more of operations 56, 58, 60, 62, and/or 64. This may result in the maps determined at operation 64 evolving over time in an ongoing manner as the users interact with the virtual space and/or each other within the virtual space.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

What is claimed is:

1. A system configured to host a virtual space to client computing devices for interaction by users of the client computing devices, wherein the users comprise a first user and a second user, the system comprising:
one or more processors configured to execute computer program modules, the computer program modules comprising:
a place module configured to instance separate spatial places within the virtual space, wherein the separate spatial places are associated with individual users, and wherein the spatial places include a first place associated with the first user and a second place associated with the second user, the place module being further configured to implement the instances of the places to determine views of the virtual space for presentation to users on the client computing devices, and to enable users to interact with the virtual space and each other in the virtual space by performing actions in the places based on input of the users received from the client computing platforms;
an interaction module configured to monitor interactions of users with the virtual space and/or each other within the virtual space; and
a map module configured to determine different maps of the virtual space for the individual users, wherein the maps include a first map for the first user and a second map for the second user, wherein the arrangement of the places of the virtual space in the first map is different than the arrangement of the places of the virtual space in the second map, and wherein the differences in the arrangements of the places of the virtual space between the first map and the second map are a function of differences in the interactions of the first user with the virtual space and/or other users and interactions of the second user with the virtual space and/or other users.

2. The system of claim 1, wherein the map module is further configured such that in the first map other places are arranged with respect to the first place based on interactions of the first user with the users associated with the other places, and the map module is further configured such that in the second map other places are arranged with respect to the second place based on interactions of the second user with users associated with the other places.

3. The system of claim 2, wherein the computer program modules further comprise a distance module configured to determine distances between places which are implemented by the map module in generating the maps, wherein the distance module is configured to determine the distances between the first place and the other places for the first map based on interactions of the first user with the users associated with the other places, and to determine the distances between the second place and the other places for the second map based on interactions of the second user with the other users associated with the other places.

4. The system of claim 1, wherein the computer program modules further comprise a relationship module configured to establish relationships between users based on communication and/or interaction between the users within the virtual space, wherein the map module is further configured such that in the first map the other places are arranged with respect to the first place based on relationships between the first user and one or more of the users associated with the other places, and wherein the map module is further configured such that in the second map other places are arranged with respect to the second place based on relationships between the second user and one or more of the users associated with the other places.

5. The system of claim 1, wherein the computer program modules further comprise a user matching module configured to determine likelihoods that specific sets of two or more users will enjoy participating together in interactions in the virtual space, and wherein the map module is further configured such that in the first map the other places are arranged with respect to the first place based on likelihoods that the first user will enjoy participating together with the other users in interactions, and wherein the map module is further configured such that in the second map the other places are arranged with respect to the second place based on likelihoods that the second user will enjoy participating together with the other users in interactions in the virtual space.

6. The system of claim 5, wherein the user matching module is configured to determine likelihoods that specific sets of two or more users will enjoy participating together in interactions in the virtual space based on one or more of relationships between users and/or usage patterns of the users.

7. The system of claim 1, wherein the map module is further configured such that the maps evolve over time based on the interactions of the users with the virtual space and/or each other.

8. A method of hosting a virtual space to client computing devices for interaction by users of the client computing devices, wherein the users comprise a first user and a second user, and wherein the method is implemented by one or more processors configured to execute one or more computer program modules, the method comprising:
executing instances of separate spatial places within the virtual space, wherein the separate spatial places are associated with individual users, and wherein the spatial places include a first place associated with the first user and a second place associated with the second user;
implementing the instances of the places to determine views of the virtual space for presentation to users on the client computing devices, and to enable users to interact with the virtual space and each other in the virtual space by performing actions in the places based on input of the users received from the client computing platforms;
monitoring interactions of users with the virtual space and/or each other within the virtual space; and
determining different maps of the virtual space for the individual users, wherein the maps include a first map for the first user and a second map for the second user, wherein the arrangement of the places of the virtual space in the first map is different than the arrangement of the places of the virtual space in the second map, and wherein the differences in the arrangements of the places of the virtual space between the first map and the second map are a function of differences in the interactions of the first user with the virtual space and/or other users and interactions of the second user with the virtual space and/or other users.

9. The method of claim 8, wherein determining the first map comprises arranging places with respect to the first place based on interactions of the first user with the users associated with the other places, and wherein determining the second map comprises arranging other places with respect to the second place based on interactions of the second user with users associated with the other places.

10. The method of claim 9, further comprising determining distances between places which are implemented in determining the maps, wherein determining the distances between the first place and the other places for the first map is performed based on interactions of the first user with the users associated with the other places, and wherein determining the distances between the second place and the other places for the second map is performed based on interactions of the second user with the other users associated with the other places.

11. The method of claim 8, further comprising establishing relationships between users based on relationship requests and acceptances received from the users, wherein determining the first map includes arranging the other places with respect to the first place based on relationships between the first user and one or more of the users associated with the other places, and wherein determining the second map includes arranging other places with respect to the second place based on relationships between the second user and one or more of the users associated with the other places.

12. The method of claim 8, further comprising determining likelihoods that specific sets of two or more users will enjoy participating in interactions within the virtual space together with each other, wherein determining the first map includes arranging the other places with respect to the first place based on determined likelihoods that the first user will enjoy participating together in interactions with the other users, and wherein determining the second map includes arranging the other places with respect to the second place based on determined likelihoods that the second user will enjoy participating together in interactions with the other users in the virtual space.

13. The method of claim 12, wherein likelihoods that specific sets of two or more users will enjoy participating in interactions together in the virtual space are determined based on one or more of relationships between users and/or usage patterns of the users.

14. The method of claim 8, wherein determining the maps comprises re-determining the maps over time such that the maps evolve over time based on the interactions of the users with the virtual space and/or each other.

15. Non-transient, electronic storage media that stores individualized maps of a virtual space associated with individual users of a system that provides the virtual space to the users, wherein the users interact with the virtual space and each other in the virtual space, the individualized maps comprising:
separate spatial places within the virtual space, wherein the separate spatial places are associated with the individual users, and wherein the spatial places include a first place associated with a first user and a second place associated with a second user;
wherein the maps include a first map individualized for the first user and a second map individualized for a second user, and
wherein the different maps of the virtual space are individualized for the individual users based on the interactions of the individual users with the virtual space and/or with each other in the virtual space such that (i) the arrangement of the places of the virtual space in the first map is different than the arrangement of the places of the virtual space in the second map, and (ii) the differences in the arrangements of the places of the virtual space between the first map and the second map are a function of differences in the interactions of the first user with the virtual space and/or other users and interactions of the second user with the virtual space and/or other users.

16. The storage media of claim 15, wherein the first map comprises an arrangement of other places with respect to the first place reflecting interactions of the first user with the users associated with the other places, and wherein the second map comprises arrangement of other places with respect to the second place reflecting interactions of the second user with users associated with the other places.

17. The storage media of claim 16, wherein the distances between the first place and the other places for the first map reflect interactions of the first user with the users associated with the other places, and wherein the distances between the second place and the other places for the second map reflect interactions of the second user with the other users associated with the other places.

18. The storage media of claim 16, wherein other places are arranged with respect to the first place in the first map to reflect relationships between the first user and one or more of the users associated with the other places, and wherein the other places are arranged in the second map with respect to the second place to reflect relationships in the virtual space between the second user and one or more of the users associated with the other places.

19. The storage media of claim 16, wherein other places are arranged with respect to the first place in the first map to reflect determined likelihoods that the first user participating in interactions in the virtual space with the other users associated with the other places, and wherein other places are arranged with respect to the second place in the second map to reflect determined likelihoods that the second user will enjoy participating in interactions in the virtual space with the other users associated with the other places.

20. The storage media of claim 19, wherein likelihoods that the first and/or second users will enjoy participating in interactions with the other users in the virtual space are determined based on one or more of relationships between users in the virtual space and/or usage patterns of the users in the virtual space.
